(19) United States
(12) Patent Application Publication
(10) Pub. No.: US 2004/0089734 A1
(43) Pub. Date: May 13, 2004

(54) Vehicle engine powered high pressure water sewer clearing apparatus and method

(76) Inventor: Timothy R. Martin, Zion, IL (US)

Correspondence Address: PYLE & PIONTEK, Suite 850, 221 N. LaSalle Street, Chicago, IL, 60601, US

(21) Appl. No.: 10/701,816

(22) Filed: Nov. 5, 2003

Related U.S. Application Data
(60) Provisional application No. 60/424,139, filed on Nov. 6, 2002.

(51) Int. Cl. B05B 9/03

(52) U.S. Cl. 239/146

(57) ABSTRACT

A vehicle mounted high pressure water cleaning apparatus includes a water delivery system, and a control system working together to provide, alternatively, high pressure water for a cleaning operation, or recirculation of water within the pump. The high pressure cleaning system includes a high pressure pump driven by the vehicle's engine through, for example, a driveshaft driven by a pulley system mounted on the engine. The high pressure pump and associated water tank and hose may all be mounted in the interior of the vehicle and heated by the vehicle's heater system. No separate auxiliary engine, power take off gear box, enclosure or heater is needed.

### CROSS REFERENCE

The present application and inventors claims the benefit of the prior U.S. Provisional Application No. 60/424,139, filed Nov. 6, 2002 by the present inventor and of the present title.

### BACKGROUND OF THE INVENTION

The present invention relates generally to systems for clearing sewers using water under high pressure. Specifically, it relates to a vehicle driven high pressure water sewer clearing apparatus.

Various devices are used for high pressure water cleaning various and particularly clearing objects such as pipes. Such high water pressure systems include apparatus to deliver water to a pipe or sewer or the like to clear and clean debris and blockage from the pipes which may have over a period of time accumulated therein. For example, tree roots frequently invade sewers and help form blockage therein, which can become impacted with typical toilet refuse, ie., toilet paper, sanitary napkins, condoms, etc.

Such cleaning apparatuses for the cleaning of pipes, sewers, and the like generally use the high pressure water delivered through a hose. The high pressure water cuts through and clears any debris or blockages which may be present. Delivery of water at high pressure can create a number of problems and requires special components such as hoses, nozzles and pumps designed to be used at high pressure.

It is known to provide such a high pressure water clearing apparatus that can be powered by a vehicle, such as by a hydraulic pump for driving a hydraulic motor which in turn powers the high pressure pump. This type apparatus has the disadvantage of complexity, high cost, and possible environmental leakage problems related to hydraulic fluids.

Typical high pressure water sewer clearing system uses a length of hose extending from a hose supply, usually mounted on a truck, usually at least a one ton type chassis or larger. The high pressure water is delivered through the hose. The controls for the apparatus are positioned at the vehicle. To properly clean or clear pipes, sewers and the like, the outlet of the hose must be placed into the sewer and is then lead some distance into the sewer or the pipe up to the blockage. Clearing and cleaning the pipe is accomplished by using the emitted high pressure water to cut down and break up the blockage. The hose is fed through the pipe up to and through the blockage. Since the hose end is in the pipe, two operators are required for the clearing process. The first operator places the hose into the pipe to be cleaned and remains in that vicinity to report on how the operation is going, including preventing possible flooding, and/or preventing the high pressure hose from breaking free and whipping about with dangerous consequences, etc. The second operator remains at the controls by the vehicle to operate the same. If only one operator is available, startup and shutdown of the high pressure system is necessary frequently, and such would require numerous trips between the vehicle and the sewer. This one operator process takes extra time due to the frequent starting and stopping of the system.

Water for a cleaning/clearing operation is typically stored in a supply tank located on the vehicle. Such supply tanks have a fixed capacity. With a single operator making frequent stops and starts and trips between the sewer and the vehicle uses water inefficiently. As water capacity is fixed, water wasted must be replaced and time is lost in having to refill the tank. The water, tank and pressure pump need to be protected from freezing weather.

High pressure water pumps utilized in cleaning a sewer operate at high pressures such as 3000 psi and require relatively large horsepower input, typically being from 5 to 20 horsepower. In the prior art, these large pumps also generally require a large space because they were run by an auxiliary gasoline or diesel engine sufficient to provide the needed horsepower for their operation. Some prior art sewer clearing vehicles have used a hydraulic pump powered off the vehicle's power take off transmission, or even a mechanical drive off of a specially installed power take off transmission located behind the vehicle's regular transmission. Using power from the vehicle transmission has the disadvantage of high costs, requiring a power take off type transmission or auxiliary power take off gearbox. A further disadvantage is that the vehicle's transmission would generally have to be left “in gear” when doing a sewer clearing job, which could be hazardous.

As briefly discussed above, hydraulic systems have problems, such as loss of engine power through the hydraulic coupling inefficiency, possible leakage of hydraulic fluid and environmental damage, and the added weight and space requirements.

It is also known to drive a high pressure pump for clearing a pipe with the pump driven off a power take off (pto) gearbox installed between a vehicle's transmission and differential. As noted above, due to the nature of a high pressure pump and its close tolerance, it is necessary to protect the pump from freezing. In prior art vehicles where the pump was located sometimes required a separate enclosure, like a pick up truck bed cap and an auxiliary heater, further complicating matters and raising costs.

Installations using or requiring a complicated pto type gearbox, can be made only on rear wheel drive vehicles, and cannot be made on front wheel drive vehicles. That is because usually it would be prohibitively expensive, if not impossible, to insert a power take off between a front wheel drive transmission and the front wheel differential due to the nature of the front wheel drive, engine, transmission and differential design.

It would be desirable to provide a high pressure water sewer clearing vehicle which can directly power a large (high horsepower requirement) jet pump of high pressure by the vehicle's engine, without the use of hydraulics, ptos, gearboxes, auxiliary engines, extra enclosures, and/or extra heaters, and which could be used with any of front wheel drive, rear wheel drive and four wheel drive vehicles and their engines.

### SUMMARY OF THE INVENTION

The present invention overcomes the problems of the prior art by providing a vehicle mounted high pressure water sewer clearing apparatus and method which is operable by a single user, and which is driven by the engine of the vehicle. Preferably, the pump is driven by the pulley system on the engine and drives a pump remote from the engine and located in heated portion of the vehicle interior. The pump may be driven by the engine's pulley system and/or a portion of that system adapted, such as by adding a pulley for driving the pump. The drive pulley in turn may drive a driven pulley, which in turn drives a bearing mounted shaft, or other mechanism, such as belts, which extends from the engine compartment to the vehicle's heated compartment to drive the high pressure pump located in the vehicle's heated compartment. In doing so the pump drive passes through the vehicle's firewall and/or engine cover or body. Thus the pump is protected from the environment and freezing temperature and can be driven without the need for hydraulics, auxiliary engines, or expensive, costly to install power take offs or power take off transmissions. No extra engine, hydraulics, enclosures or heaters are needed. The vehicle need not be of a one ton capacity, but can be much smaller, say of a ½ ton capacity or even smaller. The invention results in substantial savings in initial purchase and in operation. While a prior art vehicle might cost $80,000.00, a vehicle of the present invention is more likely to cost around $40,000.00, these being 2002 costs.

The present invention is a vehicle mounted high pressure sewer clearing apparatus and method which delivers high pressure water through a conduit or hose to clear/clean pipes, sewers and the like. The water is stored in a reservoir which, is in the vehicle's heated interior, and is pumped by a high pressure pump located in the vehicle's heated interior and delivered through a hose extending from the vehicle to a nozzle at the end, and creating the high pressure cutting water spray for clearing a blockage. A valve outside the vehicle and at the end of the hose can cause diversion of high pressure water flow from hose. This valve may be operated by the operator standing at the entrance to the sewer or pipe being cleared. This diversion-control feature can be built into the high pressure pump or constructed outside of the pump circuit.

A low voltage electrical control system is provided power by the vehicle electrical system. Use of twelve volt vehicle voltage eliminates the risks were household or higher voltage used. The electrical system includes the vehicle battery/alternator or generator as a power source, and switches, to control the operation of the magnetic clutch which connects the high pressure pump to be driven by the engine and also a speed control for the engine. The electrical system also powers a vehicle alarm system which protects the vehicle from theft when the vehicle is running and the operator is remote from the vehicle, and say at the sewer opening.

As noted, the clearing apparatus of the present invention is driven by the engine of the vehicle by coupling the engine crankshaft to a drive either a pulley integral with the engine's pulley drive system (including the engine's harmonic balancer) or a special pulley added to the engine pulley system. By choosing driving and driven pulley diameters, revolution speed ratio of the vehicle engine to that of the high pressure water pump can be controlled, and preferably the pump speed is selected to be higher than engine speed to reduce engine wear and generate high pressure.

In order to get the pump into the vehicle's interior in most locations where freezing is of concern at least sometime during the year, and for convenient operation, the high pressure pump is driven by a pump shaft extending from the driven pulley, with the pump shaft extending through the firewall or engine cover into the vehicle interior. The pump shaft is suitably supported by bearings as needed mounted on the vehicle body or frame.

This method for driving the pump at increased revolution speed results in more efficient operation of the pump of the present invention without the problems associated with a heavy auxiliary engine or an inefficient hydraulic drive system. Without need for an auxiliary engine or hydraulics, the present invention can be mounted in a small vehicle such as a van, pick up truck, and particularly a crew cab version, a SUV, stationwagon or even a passenger car, yet still carry the necessary water and have more storage space than a typical similar size prior art sewer cleaning vehicle which utilizes an auxiliary engine or hydraulic drive or a drive off of a power take off gearbox. Since a smaller vehicle may be used, the expense associated with operation of the vehicle is reduced. As noted, the clearing apparatus may all be placed within the vehicle, so as to be heated by the vehicle heater and no auxiliary heater is needed.

High pressure water flow through the hose for cleaning operations is generated by coupling the high pressure pump to the engine system of the vehicle on which the present invention is mounted. To this end, the pump shaft is coupled to and driven by the engine of the vehicle and the other end is connected to the high pressure jet pump. Unlike the prior art, in the present invention, the vehicle's transmission may be placed in “park,” the engine started and the hand brake applied, and the driver compartment locked. A locked driver's compartment with the vehicle in park or neutral is an added safety feature. When the jet pump high pressure or action is desired, the magnetic clutch control switch may be closed to energize the magnetic clutch which couples the rotating drive pulley, so it drives the driven pulley and the pump shaft to drive the high pressure jet pump. The desired water pressure may be obtained by controlling the speed of the vehicle engine. This may be accomplished using an electrically operated (solenoid) remote throttle and/or a governor. A governor or speed control of a simple nature (solenoid) may be fitted to the engine to increase speed to give a high and lower pressure, say 3000 and 1500 psi.

### DESCRIPTION OF THE DRAWINGS

FIG. 1 is a schematic plan view of a rear wheel drive or 4 wheel drive van incorporating the present invention.

FIG. 2 is a schematic side elevation view of the vehicle of FIG. 1.

FIG. 3A is a schematic view showing how the driving pulley and electromagnetic clutch are secured via an adapter to the harmonic balancer of the vehicle's engine.

FIG. 4 is a schematic of the flow system for the present invention.

FIG. 5 is a schematic plan view of an installation in a vehicle featuring a cross mounted front wheel drive or 4 wheel drive engine.

FIG. 6 is a partial schematic elevation view of the belt drive of FIG. 4.

FIG. 7 is a view similar to FIG. 6 of an alternative partial schematic of the belt drive for the vehicle of FIG. 4.

FIG. 8 is another alternative partial schematic elevational view of a belt drive for the vehicle of FIG. 4.

FIG. 9 is a partial plan view of the belt drive of FIG. 8.

FIG. 10 is a schematic elevational view of an alternative shaft drive for a rear drive vehicle with the driveshaft for the pump mounted below the body or chassis.

### DESCRIPTION OF THE PREFERRED EMBODIMENTS

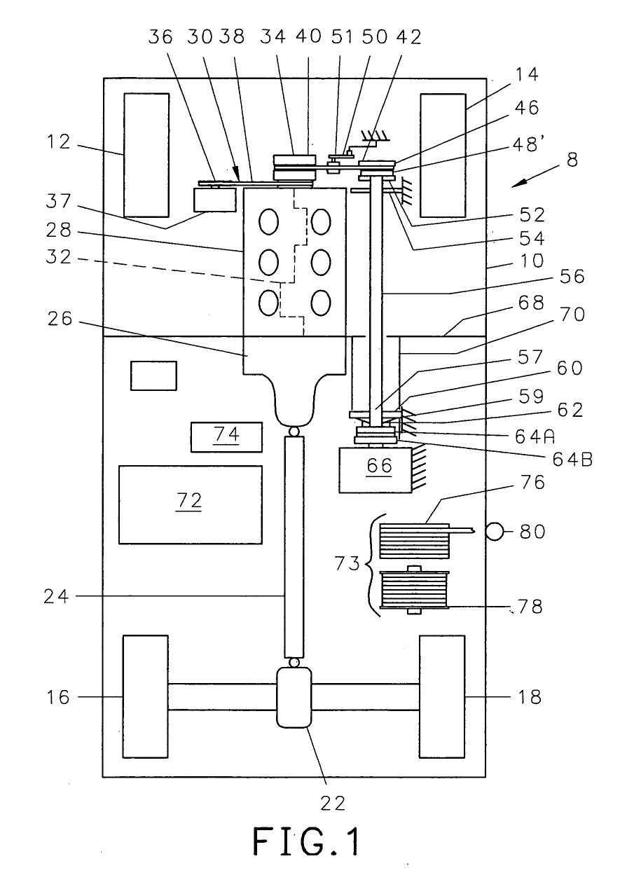

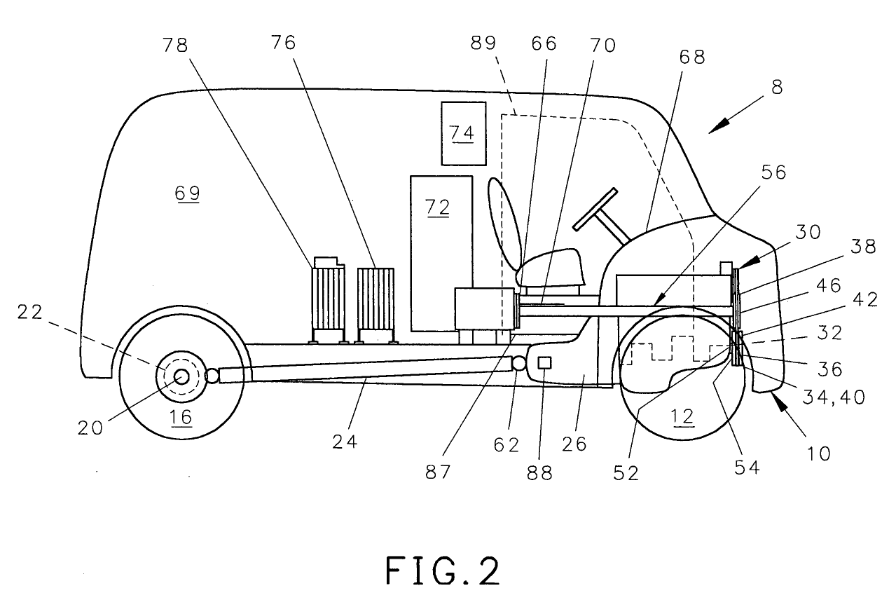

Referring now to the drawings in greater detail there is illustrated in FIGS. 1-4 a first embodiment of the apparatus of and for use with the method of the present invention, generally identified by reference numeral 8.

As disclosed, the apparatus 8 includes a vehicle chassis or body 10, with the body 10 also having mounted thereon left and right front tires 12 and 14, respectively, and left and right rear tires 16 and 18, respectively. The rear tires 16 and 18 are mounted on a rear axle 20 including a differential 22. The differential 22 is mechanically engaged to a driveshaft 24, which is driven by a transmission 26, which in turn is driven by an engine 28. While not shown, the front wheels 12 and 14 can also be driven off the transmission 26 and/or a transfer case, not shown, as is conventional to provide all or 4 wheel drive.

The engine 28 includes an engine pulley system 30 with a crankshaft 32 of the engine 28 driving a crankshaft pulley 34 of the pulley system 30. The pulley system 30 further incorporates a harmonic balancer and driven pulley 36 which engages an engine pulley system belt 38 to drive accessories, such as an alternator 37, power steering pump, etc.

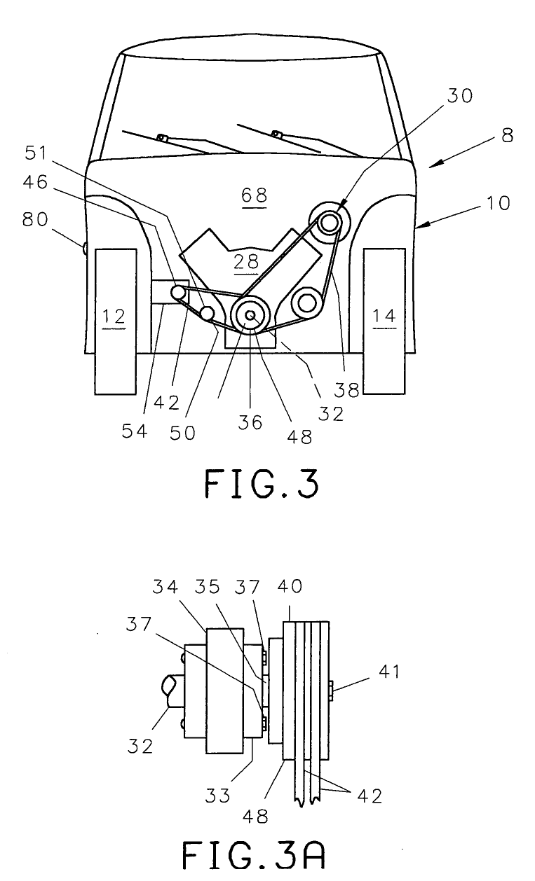

If the engine's existing pulleys cannot be utilized to drive the pump, if necessary a second driving pulley 40 can be added. The drive pulley as shown in FIG. 3A is driven by the crank shaft 32, via an adapter 48 and 35 attached by bolts 37 to the pulley/harmonic balancer 36 of the engine. Rather than directly drive the pulley 40 with the crankshaft, it is connected through clutch means, and in this instance, an electromagnetic clutch 48, so that by energizing or degenergizing the clutch, causes the rotation or non-rotation of the pulley 40. The electromagnetic clutch is partially retained by bolt 41. The clutch 48 is model #MA-7A-C112 made by Ogura Clutch Company, Ltd. While a clutch is very convenient, it is not absolutely necessary. One could remove the belts and reinstall them when they wanted to run the pump. Such practice would be very inconvenient but still within the present invention. Another example would be merely to let the belt idle and engage it only when you want to drive the pump. Neither of these procedures is as convenient as the clutch, and particularly, the electromagnetic clutch. As shown, the driving pulley 40 drives at least one or more secondary belts 42. In turn, a driven pulley 46 engages with and can be driven by the at least one secondary belt 42. Various type belts can be used, single (wide) 2 or 3, or cogged belts. While belts are shown, it should be understood that other equivalent mechanisms could be used, such as gears, etc. This driven pulley 46 can be engaged and disengaged from being driven by the belts 42 through use of an electromagnetic clutch 48. To regulate the tension on the belts 42, an adjustable idler pulley mount 50 can be provided and mounted to the chassis or frame, the adjustable idler pulley 51 being within the confines of the loop formed by the belts 42. Thus depending upon positioning of the idler pulley 51, tension on the belt 42 may be established. Of course, the clutch means could be located elsewhere, such as on the driven pulley or further down closer to the pump.

The driven pulley 46 is supported by a front bearing 52 mounted on a front bearing bracket 54. Preferably, these bearings are of a spherical type to accommodate any misalignment. Mounted within the bearing 52 in a fashion to be rotatable by the driven pulley 46 is a pump driveshaft 56. The shaft 56 extends rearwardly and has a rear portion 57 thereof again mounted rotatably within a rear bearing 62 mounted on a rear bearing bracket 60. A rear end 59 of the shaft 56 engages and rotates a first coupling flange 64A which engages a second coupling flange 64B of a high pressure water pump 66, the shaft 56 driving the pump 66 through the joined driven coupling flanges 64A and 64B. The coupling flanges, if desired, could be configured to cooperate with a clutch means.

It will be understood that the pump 66 and the rear portion 57 of the shaft 56 extend past a firewall or engine cover 68 of the vehicle, extending into the interior 69 thereof and particularly the passenger or vehicle's heated compartment. For this safety and other reason, a shield 70 is provided to keep moving parts extending from the engine cover or firewall into the vehicle's interior isolated therein and to retain heat therein. If necessary, to make room to run the drive system through the passenger compartment 69, a seat riser 81 may be provided, with the driveshaft or system passing through or below the riser 81.

The pump 66 is provided to pump water from a water tank 72 (say of 100-50 gallon size), positioned interior of the firewall 68 as well, into and through a hose assembly 73 to be described.

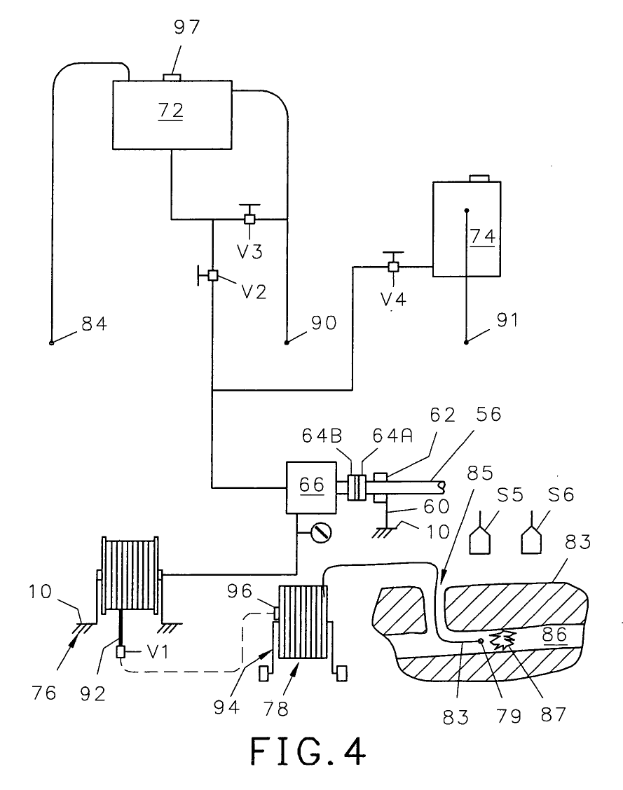

The tank 72 is positioned in the interior or passenger compartment 69 for the purpose of using heat therein to keep water in the tank 72 from freezing. When the vehicle is to be stored outside for several hours or more in freezing temperature, this water tank should be drained. Antifreeze from an antifreeze tank 74, preferably having a capacity of 5 to 6 gallons, may be purged into the water system of FIG. 4 for keeping the system subsequently operable in cold weather. It being understood that, where for example the vehicle is to be stored unheated overnight, the water tank and water system to the extent possible is first drained and then antifreeze passed through to prevent freeze damage.

Hose assembly 73 comprises dual reeled hoses 76 and 78, each say of 100 to 150 feet in length. The first reeled hose 76 is mounted to the vehicle and can be referred to as a vehicle hose 76. The second reeled hose 78 is portable and can be referred to as a sewer hose 78. The hose 78 has a jet spray head 79 at a distal end 83 thereof. The vehicle hose reel 78 is fixedly mounted within the vehicle body 10 and has valve V1 on a free end thereof. This free end can be taken out of the vehicle interior 69 through a hose exit door 80 provided on the vehicle body 10 and in use is taken to or near the sewer or pipe to be cleared/cleaned.

The sewer hose reel 78 on the other hand is mounted on a wheeled reel 94 and is transportable to a position near sewer opening 85. The free end 92 of the vehicle hose 76 is engageable to a proximal end 96 of sewer hose 78, with valve V1 being available at the site where the sewer opening 85 is located. The position of valve V1 on the end of hose 76 near the sewer permits the single operator to control delivery of pressurized water to the sewer hose 78. Connection between the hoses 76 and 78 can be formed in any suitable manner, such as through use of quick connect couplings (not shown).

In operation, and particularly viewing FIG. 4, the tank 72 is filled with water via a water fill connection 84 and valve V3 and valve V4 (both high pressure ball valves) are closed. Connection 84 is designed to be engageable by, for example, a garden hose (not shown) for filling, since a preferred capacity for the tank 50 is 100 gallons or less. Also, a cap 97, with a vent therein, may be provided for venting the tank of air as it fills. Valve V2 (ball valve) is opened, switch S5 is energized to energize the magnetic clutch to connect pump 66 to the operating engine 28. High pressure water is then provided to reeled hose 76. As valve V1 (ball valve) is positioned between reeled hose 76 and reeled hose 78 which is fed into a sewer opening 85 in ground 83. Valve V1 may be opened to send high pressure water to reeled hose 78 and into a sewer 86 to clear blockage 87 with the jet spray produced by the pump 66. Water is run, continuously or pulsed, until the blockage 87 is cleared. To stop the flow of water into the sewer 86 valve V1 is closed and water harmlessly recirculates in pump 66. The pump is made by Gorilitz and is a model 3500, rated at 10 gph at 3000 psi.

When finished, the engine 28 of the vehicle may be stopped. An alarm system 88 of the vehicle is set up to stop the engine 28 of the vehicle if a passenger compartment door 89 (shown in phantom) is opened or the vehicle's transmission is put in gear. This provides a safe, anti-theft feature, which is desirable as the vehicle operator may be remote from the vehicle and at or near the sewer.

To disengage the pump temporarily, the vehicle's operator need only to disconnect via magnetic clutch by opening switch S5. Also, temporarily closing valve V1 will stop water flow out hose 78. Switch S6 provides a throttle control (solenoid boosts engine idle speed) to provide two engine speeds, idle plus a higher speed. The various pulleys are sized so idle gives 1500 psi from pump 66 and with switch S6 closed the throttle control raises engine speed higher so pump 66 delivers 3000 psi. For example, the driving pulley could be from 5 to 10 inches in diameter, while the driven pulley could be from 2 to 5 inches in diameter, respectively. With a large pump, it will be driven slower so that the ratio of drive pulley to driven pulley will be smaller than for a small pump, giving a lower pump speed (and more torque) for a given engine speed.

To drain water from the tank 72 valve V3 is opened and water will drain out of tank 72 via an overflow drain 90 below the vehicle chassis 10. To protect pump 66 and hoses 76 and 78, antifreeze from tank 74 is run through these structures. To do so, valve V2 is closed and valve V1 is connected via connector 91 to tank 74 for antifreeze return. Valve V4 is opened and pump 66 is used to circulate antifreeze from tank 74 via valve V4 through pump 66, through hose 76 and back to tank 74. When antifreeze can be seen to return through a clear section of an antifreeze return line, pumping antifreeze is stopped and the system is freeze protected. To restart or reuse the system, merely supply water from tank 72 through valve V2 to pump 66 (with valves V2 and V4 closed) to pump the small amount of antifreeze back into the tank 72. Then valve V1 is disconnected from the antifreeze return line and the system is ready for another job.

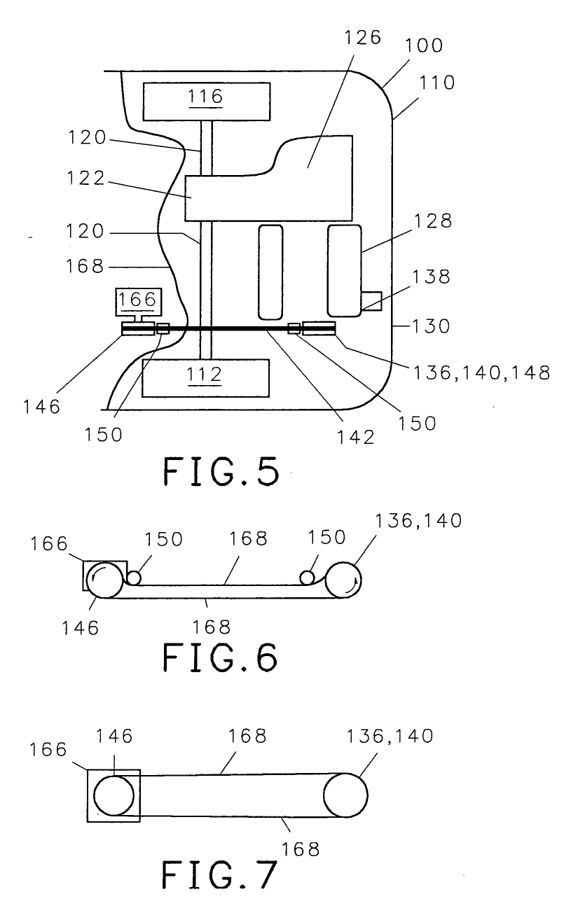

Turning now to FIGS. 5 and 6, a second embodiment is shown therein which may be considered a front wheel drive or cross mounted engine system. In this embodiment, as in the following embodiments, like items are similarly numbered but given a number 100, or 200 higher, (40 becomes 240 or 340, etc.), and for the sake of brevity will not be redescribed, with changes in each embodiment only being pointed out.

Thus, in FIGS. 5 and 6, it will be seen that pump 166 is driven by a driven pulley 146 which in turn is driven by a driving belt 142 which in turn is driven by a driving pulley 136 of engine pulley system 130.

Adjustable idler pulleys 150 are seated along the flight of the driving belt 142, to decrease the normal amount of clearance for and distance between the belt runs which would be required. That is, the distance between the two belt runs are reduced to an inch or two, reducing the size of any openings required in the vehicle structure. Of course if possible, a more conventional belt run like that shown in FIG. 7 could be used.

Thus, again, the pump 166 is mounted within the interior 69 of the vehicle 8.

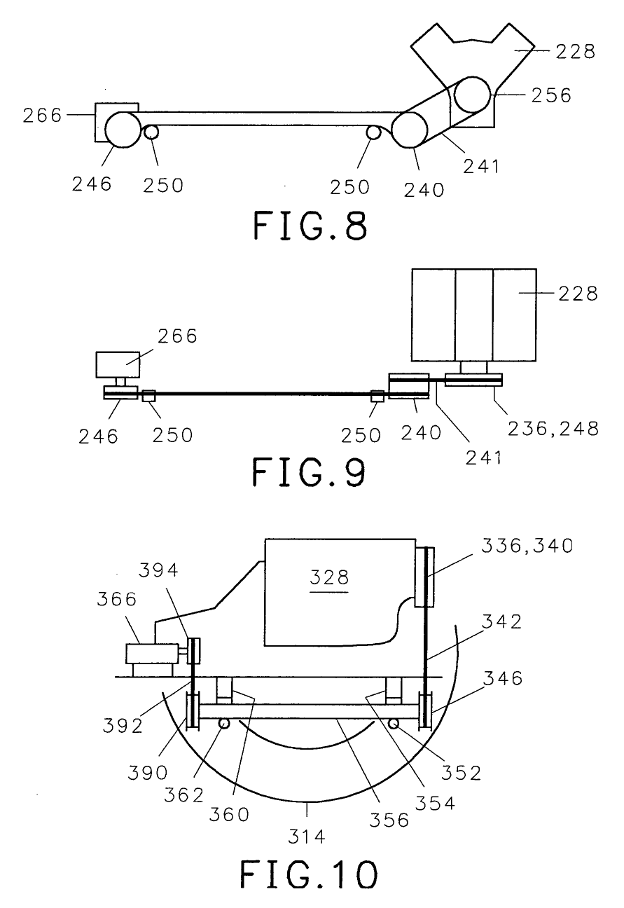

Alternatively, as shown in FIGS. 8 and 9, a driving pulley 240 could be added and would be driven by a belt 241 which would in turn be driven by driving pulley 236 of the engine pulley system 230. This type installation could be used where engine compartment crowding required the pump drive to be moved elsewhere.

Still a further alternative is shown in FIG. 10 wherein the drive system and its pump shaft for the pump 366, which is substantially similar to the first embodiment, is suspended below the vehicle chassis 10, between the front wheels 14 and 16 (not shown) thereof.

Here the belt 342 driven by the driving pulley 336 of the engine pulley system 330 extends downwardly under the engine compartment, and engages a driven pulley 346 which has a pump driveshaft 356 engaged thereto in a manner to rotate therewith. The other end of the shaft 356 engages a pulley 390 which in turn engages a drive pulley 394 used to drive the pump 366. At this end of the drive system, the belt 392 passes through an opening (not shown) in the underside of the vehicle body 10 so the pump 366 remains positioned within the interior compartment of the vehicle body 10.

The pump driveshaft 356 is suspended from the vehicle chassis 10 and is carried by front and rear bearings 352 and 362 respectively, which in turn are suspended from the vehicle chassis 810 by front and rear bearing brackets 354 and 360 respectively.

Thus it will be seen from the exemplary embodiments presented that the drive systems for the pump 66, 266, 366 are not limited in nature.

In one concept of the invention, the pump and water tanks may be positioned within the warmable interior compartment 69 of the vehicle body 10, and the pump driven directly off the engine of the vehicle.

While an electromagnetic clutch is shown, other type connecting of clutch means could be used. While ball valves are used, other type valves could be used.

While preferably high pressure quick disconnects are used where a fast connection is used, other type connections, such as threaded connections could be used.

While the invention is described with respect to a mechanical device in the form of a high pressure water pump, the inventive concept could be utilized to drive other forms of mechanical devices than a high pressure water, such as other types of pumps, a blower for moving air or other gases or for creating a vacuum, an air compressor for operating tools, or other type mechanical devices. In such instance, the mechanical device could be located in the heated or interior compartment, but yet be driven by the vehicle's engine. Other modifications including any equivalent elements and steps may be made and are considered to be within the scope of the invention.

What is claimed is:

1. A sewer or the like clearing vehicle comprising a vehicle having a heated compartment heated by a heater of the vehicle, an engine for driving the vehicle, a transmission connected to the engine, wheels upon which the vehicle is mounted, said engine powering the transmission, said transmission driving the wheels, said engine having a pulley system for driving auxiliary devices for at least generating electricity, a water tank mounted in the heated compartment of said vehicle, a high pressure water pump mounted in the heated compartment of said vehicle, means for taking power from said pulley system of said vehicle for driving said high pressure water pump to take water from said water tank and supply it to outside the vehicle for clearing the sewer or the like, whereby said high pressure water pump is economically driven without disruption of the power flow path from the engine to the wheels of the vehicle and the high pressure water pump and water tank are protected from cold weather by the heated compartment of the vehicle.

2. Apparatus as in claim 1, wherein said engine has a crankshaft, said means for taking power from said pulley system comprising a driving pulley mounted to turn with said crankshaft, a driven pulley mounted on said vehicle adjacent said driving pulley, and means for diving said driven pulley with said driving pulley.

3. Apparatus as in claim 2, further comprising shaft means, said shaft means being connected to said driven pulley, said shaft means driving said high pressure water pump.

4. Apparatus as in claim 3, wherein said vehicle has an engine compartment and said engine and one end of said shaft is in said engine compartment, and the other end of said shaft extends into said heated compartment.

5. Apparatus as in claim 4, further comprising at least one bearing, said at least one shaft bearing being mounted in said vehicle to rotatably mount at least one of said driven pulley and shaft.

6. Apparatus as in claim 5, wherein there are two bearings, one bearing being located near the driven pulley and the other bearing being located near the high pressure pump.

7. Apparatus as in claim 6, wherein said vehicle has a firewall, said shaft extending through said firewall, and said high pressure pump is mounted on the opposite side of said firewall than said engine.

8. Apparatus as in claim 1, wherein said means for taking power from said pulley system includes clutch means for one of selectively connecting and disconnecting said high pressure pump to be operated by said engine.

9. Apparatus as in claim 8, wherein said clutch means is carried on said engine.

10. Apparatus as in claim 9, further comprising a driving pulley and a driven pulley and said engine having a crankshaft, said clutch means being driven by said crankshaft and driving said driving pulley.

11. Apparatus as in claim 1, wherein said transmission has an engine operating non-driving wheel or neutral position, said high pressure water pump being operable by said engine when said transmission is in said engine operating non-driving wheel or neutral position, whereby said high speed water pump may be operated without moving the vehicle and/or with said transmission in said engine operating non-driving wheel or neutral position.

12. A sewer or the like clearing vehicle comprising a vehicle having a heated compartment heated by a heater of the vehicle, an engine for driving the vehicle, a transmission connected to the engine, wheels upon which the vehicle is mounted, said engine powering the transmission, said transmission driving the wheels, said engine having a pulley system for driving auxiliary devices for at least generating electricity, a water tank mounted in the heated compartment of said vehicle, a high pressure water pump mounted in the heated compartment of said vehicle, means for taking power from said pulley system of said vehicle for driving said high pressure water pump to take water from said water tank and supply it to outside the vehicle for clearing the sewer or the like, said engine having a crankshaft, said means for taking power from said pulley system comprising a driving pulley mounted to rotate with said crankshaft, a driven pulley mounted on said vehicle adjacent said driving pulley, means for diving said driven pulley with said driving pulley, shaft means, said shaft means being connected to said driven pulley, said shaft means driving said high pressure water pump, said vehicle having an engine compartment and said engine and one end of said shaft being in said engine compartment, and the other end of said shaft extends into said heated compartment, at least one shaft bearing being mounted in said vehicle to rotatably mount one of said driven pulley and shaft, said at least one shaft bearing being located near one of the driven pulley and the high pressure pump, said vehicle having a firewall and said shaft extends through said firewall, said high pressure pump being mounted on the opposite side of said firewall from said engine, and clutch means for one of selectively connecting and disconnecting said high pressure pump to be operated by said engine, said clutch means being carried on said engine and being rotated by said crankshaft and driving said driving pulley, said transmission having at least one engine operating non-driving wheel position, said high pressure water pump being operable by said engine when said transmission is in said at least one engine operating non-driving wheel position, whereby said high speed water pump may be operated without moving the vehicle and/or with said transmission in said at least one engine operating non-driving wheel position.

13. A method of making a sewer or the like clearing vehicle having an engine, a transmission driven by the engine, wheels driven by the transmission and a heated compartment, comprising the steps of mounting a water tank in the heated compartment, mounting a high pressure water pump in the heated compartment, supplying the high pressure water pump with water from said water tank, providing means for taking the high pressure water supplied by said water pump to the sewer or the like, providing a belt, driving the belt with the engine of the vehicle, providing means for the driving belt to drive the high pressure water pump located in the heated compartment of the vehicle, whereby a sewer or the like may be cleaned by high pressure water provided by the high pressure water pump driven by the vehicle engine without making disruptions or changes in the wheel driving system of the vehicle.

14. A method as in claim 13, further comprising the steps of mounting one or more bearings in said vehicle, and rotatably mounting a shaft in said bearings, rotating the shaft with the belt.

15. A method as in claim 14, wherein said vehicle has a firewall separating the engine from the heated compartment, providing an opening in the firewall, locating the shaft to extend from the engine through the opening into the heated compartment, using the shaft in the heated compartment for driving the high speed water pump.

16. A method as in claim 14, wherein said vehicle has a firewall separating the engine from the heated compartment, passing the shaft from said engine toward said heated compartment and below said firewall, driving said high speed pump with said shaft.

17. A method as in claim 14, including providing an opening in said vehicle adjacent said shaft end adjacent said pump, and extending means on said shaft for driving said pump through said opening.

18. A method as in claim 13, including mounting a clutch between one of said engine and said high speed pump, whereby said clutch may be used for selectively driving said high speed pump from said engine.

19. A method as in claim 13, wherein said vehicle has a firewall separating the engine from the heated compartment, further comprising the steps of mounting one or more bearings in said vehicle, and rotatably mounting a shaft in said one or more bearings, providing an opening in the firewall, locating the shaft to extend from the engine through the opening into the heated compartment, using the shaft in the heated compartment for driving the high speed water pump, mounting a clutch between one said engine and said high speed pump, using said clutch for selectively driving said high speed pump.

20. A method as in claim 13, wherein said vehicle has a firewall separating the engine from the heated compartment, passing the shaft from said engine toward said heated compartment and below said firewall, driving said high speed pump with said shaft, mounting one or more bearing in said vehicle, and rotatably mounting said shaft in said one or more bearings, rotating the shaft with the belt, mounting a clutch between one said engine and said high speed pump, using said clutch for selectively driving said high speed pump.

21. A vehicle carrying a mechanical device and having an interior compartment, an engine for driving the vehicle, a transmission connected to the engine, wheels upon which the vehicle is mounted, said engine powering the transmission, said transmission driving the wheels, said engine having a pulley system for driving auxiliary devices for at least generating electricity, the mechanical device being mounted in the interior compartment of said vehicle, and means for taking power from said pulley system of said vehicle for driving said mechanical device, whereby said mechanical device is economically driven without disruption of the power flow path from the engine to the wheels of the vehicle and the mechanical device is protected being in the interior compartment of the vehicle.
